(19) United States
(12) Patent Application Publication
(10) Pub. No.: US 2006/0059112 A1
(43) Pub. Date: Mar. 16, 2006

(54) Machine learning with robust estimation, bayesian classification and model stacking

(76) Inventors: Jie Cheng, Princeton, NJ (US); Bernd Wachmann, Lawrenceville, NJ (US); Claus Neubauer, Monmouth Junction, NJ (US)

Correspondence Address: Siemens Corporation;Intellectual Property Department, 170 Wood Avenue South, Iselin, NJ, 08830, US

(21) Appl. No.: 11/208,988

(22) Filed: Aug. 22, 2005

Related U.S. Application Data
(60) Provisional application No. 60/604,302, filed on Aug. 25, 2004.
(60) Provisional application No. 60/604,301, filed on Aug. 25, 2004.
(60) Provisional application No. 60/605,281, filed on Aug. 27, 2004.

(51) Int. Cl. G06F 15/18

(52) U.S. Cl. 706/12

(57) ABSTRACT

A system and method for machine learning are provided, the system including a processor, an adapter for receiving instances for two different classes where each instance has a vector of feature values, a filtering unit for estimating distances between two corresponding instances of the two different classes for each of a plurality of estimators, a selection unit for calculating a corresponding p-value for each distance where the p-value is the statistical significance that the two feature vectors of the corresponding instances have different origins, and an evaluation unit for combining the different estimators by choosing the highest calculated p-value; and the method including receiving instances for two different classes, each instance having a vector of feature values, estimating distances between two corresponding instances of the two different classes for each of several of estimators, calculating a corresponding p-value for each distance, where the p-value is the statistical significance that the two feature vectors of the corresponding instances have different origins, and combining the different estimators by choosing the highest calculated p-value.

### CROSS-REFERENCE TO RELATED APPLICATIONS

This application claims the benefit of U.S. Provisional Application Ser. No. 60/604,302 (Attorney Docket No. 2004P14494US), filed Aug. 25, 2004 and entitled “Improving Model Stacking and Averaging by Rescaling Classifiers' Outputs”, which is incorporated herein by reference in its entirety. This application further claims the benefit of U.S. Provisional Application Ser. No. 60/604,301 (Attorney Docket No. 2004P14500US), filed Aug. 25, 2004 and entitled “Combination of Feature Selection and Bayesian Networks for Enhanced Pattern Recognition and Classification”, which is incorporated herein by reference in its entirety. In addition, this application claims the benefit of U.S. Provisional Application Ser. No. 60/605,281 (Attorney Docket No. 2004P14644US), filed Aug. 27, 2004 and entitled “A Combined Approach to Robust Estimators”, which is incorporated herein by reference in its entirety.

### BACKGROUND

Machine learning typically involves classification tasks. In bioinformatics, for example, such classification tasks might include classifying patients having certain cancers into different subtypes based on their gene expression data; early detection of cancer using serum proteomic mass spectrum data; predicting the bioactivity of chemical compounds based on their three-dimensional properties, and the like.

These datasets have the common characteristics that the dimensions of the feature vector are often from a few thousand to several hundred thousand; the sample sizes are normally from less than one hundred to several hundred; and the data sets are sometimes highly imbalanced such as by having more samples in a particular class than in other classes. These characteristics present challenges to the tasks of machine learning.

### SUMMARY

These and other drawbacks and disadvantages of the prior art are addressed by a system and method for machine learning with robust estimation, Bayesian classification and model stacking.

An exemplary machine learning system includes a processor, an adapter in signal communication with the processor for receiving instances for two different classes where each instance has a vector of feature values, a filtering unit in signal communication with the processor for estimating distances between two corresponding instances of the two different classes for each of a plurality of estimators, a selection unit in signal communication with the processor for calculating a corresponding p-value for each distance where the p-value is the statistical significance that the two feature vectors of the corresponding instances have different origins, and an evaluation unit in signal communication with the processor for combining the different estimators by choosing the highest calculated p-value.

An exemplary method for machine learning includes receiving instances for two different classes, each instance having a vector of feature values, estimating distances between two corresponding instances of the two different classes for each of several estimators, calculating a corresponding p-value for each distance, where the p-value is the statistical significance that the two feature vectors of the corresponding instances have different origins, and combining the different estimators by choosing the highest calculated p-value.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches machine learning with robust estimation, Bayesian classification and model stacking in accordance with the following exemplary figures, in which:

FIG. 1 shows a schematic diagram of a system for machine learning in accordance with an illustrative embodiment of the present disclosure;

FIG. 2 shows a table for a two-class problem of machine learning in accordance with an illustrative embodiment of the present disclosure;

FIG. 3 shows a flow diagram of a method for machine learning using robust estimation in accordance with an illustrative embodiment of the present disclosure;

FIG. 4 shows a flow diagram of a method for machine learning using a feature selection and Bayesian networks in accordance with an illustrative embodiment of the present disclosure;

FIG. 5 shows a flow diagram of a method for machine learning using a Bayesian classification in accordance with an illustrative embodiment of the present disclosure;

FIG. 6 shows a schematic diagram of a model stacking system for machine learning in accordance with an illustrative embodiment of the present disclosure; and

FIG. 7 shows a flow diagram of a model stacking method for machine learning in accordance with an illustrative embodiment of the present disclosure.

### DETAILED DESCRIPTION OF PREFERRED EMBODIMENTS

The present disclosure provides for machine learning with robust estimation, Bayesian classification and model stacking. An exemplary embodiment teaches machine learning using Bayesian network (BN) based frameworks for high-dimensional data classification. A framework includes data pre-processing and feature filtering, BN classifier learning with feature selection, and model evaluation using Region of Convergence (ROC) curves. The exemplary embodiment framework is highly robust and uses a Markov blanket based feature selection, which is a fast and effective way to discover the optimal subset of features.

An exemplary embodiment machine-learning framework includes data pre-processing and feature filtering, efficient Bayesian network (BN) based classifier learning with feature selection, and robust performance evaluation using cross-validation and ROC curves. BN models offer the advantage of graphically representing the dependencies or correlations between different features.

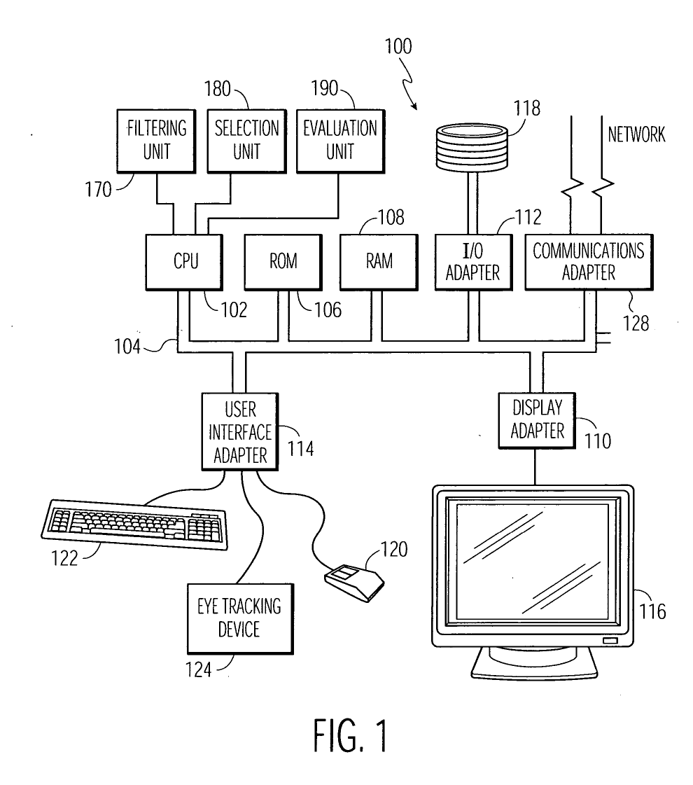

As shown in FIG. 1, a system for machine learning, according to an illustrative embodiment of the present disclosure, is indicated generally by the reference numeral 100. The system 100 includes at least one processor or central processing unit (CPU) 102 in signal communication with a system bus 104. A read only memory (ROM) 106, a random access memory (RAM) 108, a display adapter 110, an I/O adapter 112, a user interface adapter 114 and a communications adapter 128 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114.

A filtering unit 170, a selection unit 180 and an evaluation unit 190 are also included in the system 100 and in signal communication with the CPU 102 and the system bus 104. While the filtering unit 170, selection unit 180 and evaluation unit 190 are illustrated as coupled to the at least one processor or CPU 102, these components are preferably embodied in computer program code stored in at least one of the memories 106, 108 and 118, wherein the computer program code is executed by the CPU 102.

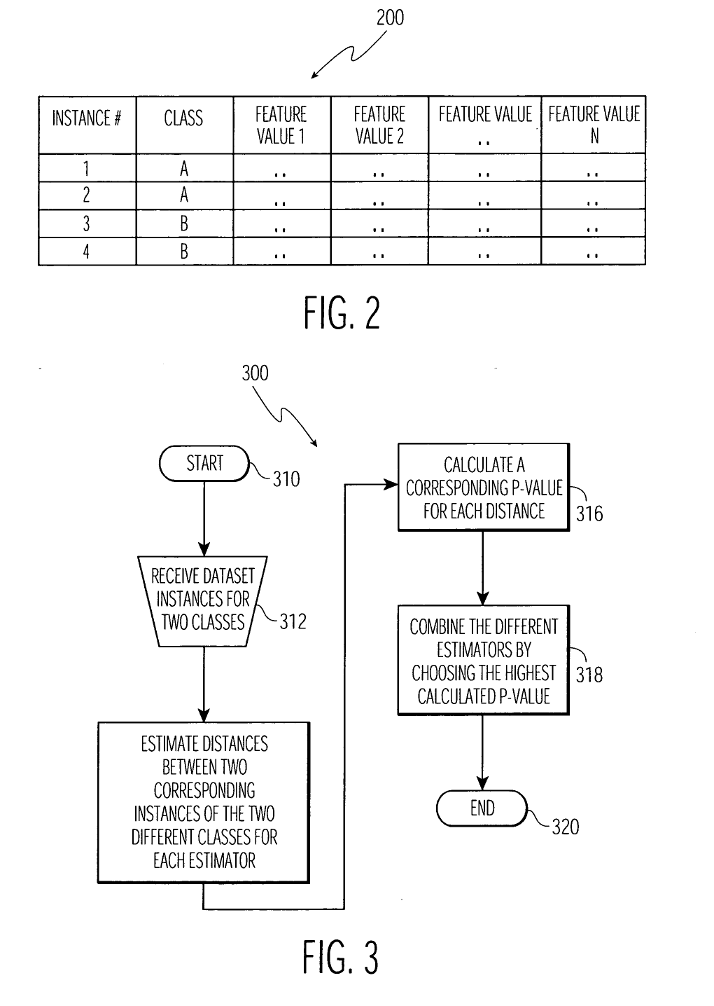

Turning to FIG. 2, a table for a two-class problem of machine learning is indicated generally by the reference numeral 200. The table 200 includes classes A and B. Each class is represented by two instances. Each instance has N feature values.

Turning now to FIG. 3, a method of machine learning is indicated generally by the reference numeral 300. The method 300 includes an input block 312 that receives instances for two different classes, each instance having a vector of feature values. The block 312 passes control to a function block 314. The function block 314 estimates distances between two corresponding instances of the two different classes for each of several of estimators. The block 314 passes control to a function block 316. The block 316 calculates a corresponding p-value for each distance, where the p-value is the statistical significance that the two feature vectors of the corresponding instances have different origins, and passes control to a function block 318. The block 318 combines the different estimators by choosing the highest calculated p-value.

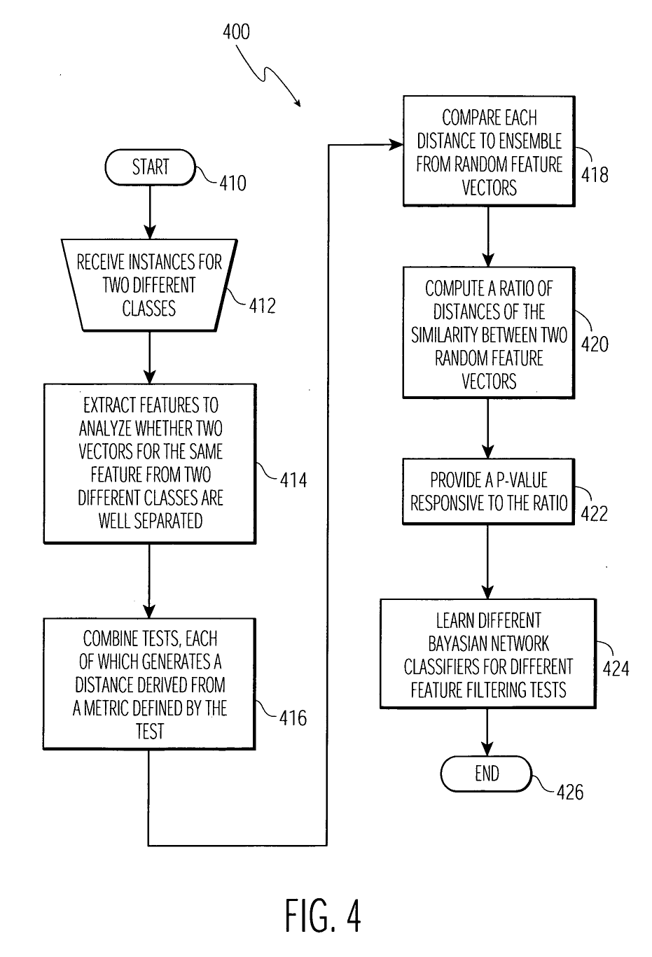

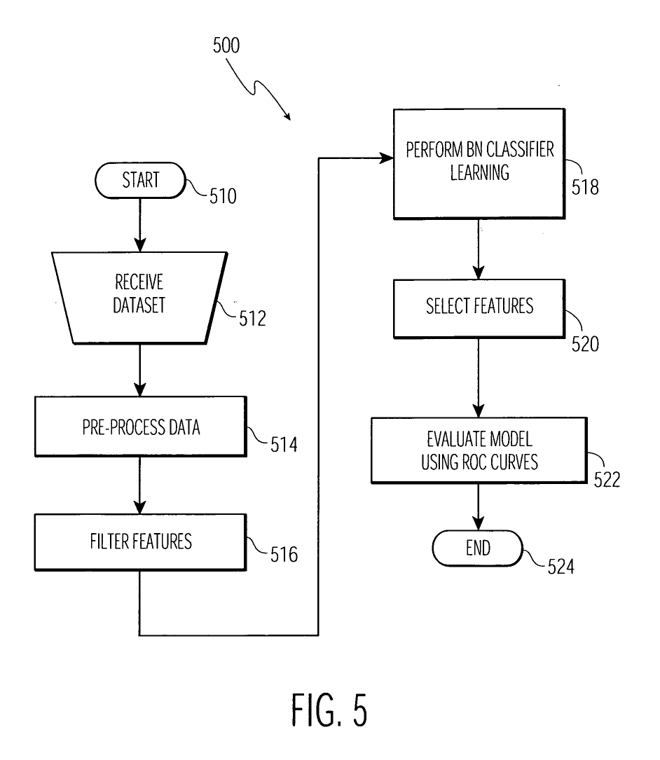

As shown in FIG. 4, a method of machine learning is indicated generally by the reference numeral 400. The method 400 includes an input block 412 for receiving instances for two different classes, each instance having a vector of feature values.

The block 412 passes control to a function block 414. The block 414 extracts features to analyze whether two vectors for the same feature from two different classes are well separated, and passes control to a function block 416. The block 416 combines several tests, each of which generates a distance derived from a metric defined by the test, and passes control to a function block 418. The block 418 compares each distance to an ensemble of distances that is calculated from random feature vectors stemming from the original feature vectors, and passes control to a function block 420. The block 420 in turn, computes a ratio of distances indicative of the similarity between two random feature vectors compared to the original feature vectors and the ensemble of distances, and passes control to a function block 422. The block 422 provides a p-value responsive to the ratio, where the p-value is the statistical significance that the two feature vectors have different origins, and passes control to a function block 424. The block 424 learns several different Bayesian network classifiers in response to several different feature-filtering tests, respectively.

Turning to 5, an exemplary method for machine learning using a Bayesian network framework is indicated generally by the reference numeral 500. The method 500 includes a start block 510 that passes control to an input block 512. The input block 512 receives a dataset and passes control to a function block 514. The function block 514, in turn, pre-processes the data and passes control to a function block 516. The function block 516 filters features of the data and passes control to a function block 518.

The function block 518 performs Bayesian network (BN) classifier learning and passes control to a function block 520, which selects features. The function block 520, in turn, passes control to a function block 522, which evaluates the model using ROC curves. The function block 522 passes control to an end block 524.

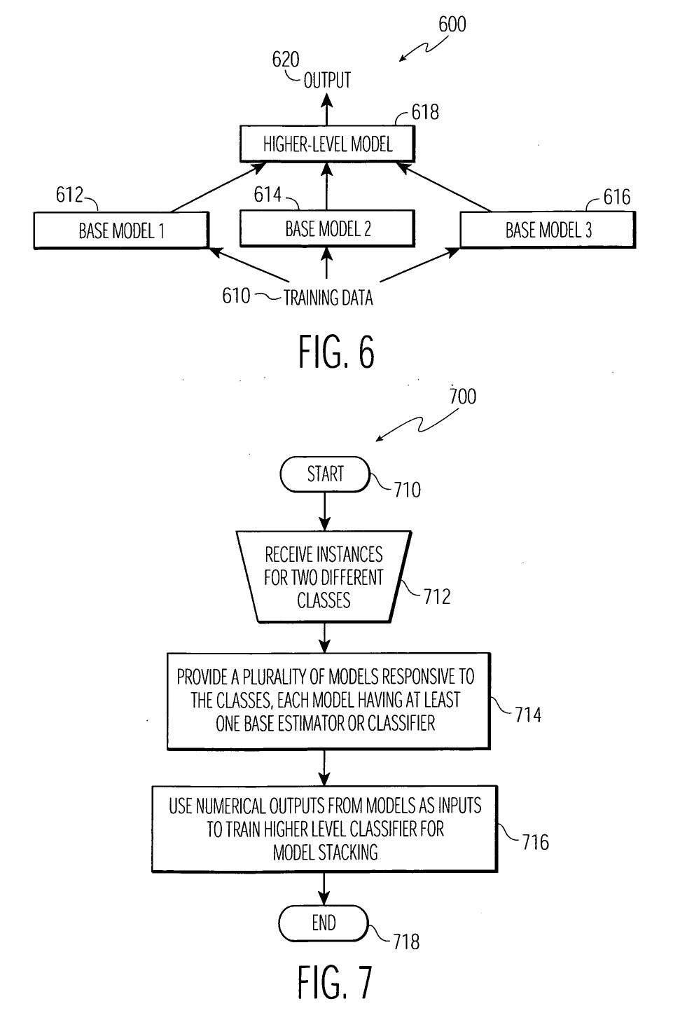

Turning now to FIG. 6, a model stacking system for machine learning is indicated generally by the reference numeral 600. The system 600 receives training data 610 into first base model 612 second base model 614, and third base model 616. The outputs of the base models are passed to a higher-level model 618, which, in turn, provides an output 620.

As shown in FIG. 7, a method of machine learning is indicated generally by the reference numeral 700. The method 700 includes an input block 712 for receiving instances for two different classes, each instance having a vector of feature values. The block 712 passes control to a function block 714, which provides a plurality of models responsive to the classes, each model having at least one base estimator or classifier. The block 714, in turn, passes control to a function block 716, which uses numerical outputs from the plurality of models as inputs to train a higher level classifier for model stacking, where each base classifier and the higher level classifier may be based on a different formalism.

In an exemplary method embodiment, a combined approach to robust estimators focuses on a machine-learning problem that frequently occurs in bioinformatics. It shall be understood that alternate embodiments may be applied in other fields of machine learning. Thus, the bioinformatics embodiment is merely exemplary, while alternate embodiments are not limited to the field of bioinformatics, having applicability in other fields.

The exemplary method applies to a two-class learning problem. Each class is represented by instances, and each instance contains a vector of feature values. For clarification, the table 200 of FIG. 2 shows a two-class problem, where each of classes A and B is represented by two instances, each instance having N feature values.

The feature selection aims to identify features, which contribute information to distinguish the two different classes. A striking challenge is that each instance might be represented by a very large number of values, such as 10,000 or more, while the classes are represented by a very small number of instances, typically less than 100 in bioinformatics applications. Therefore, it can happen by chance that feature values seem to carry information when in actuality they do not, which can lead to the problem of over-fitting and subsequently to reduced quality in classification. The algorithm described here combines several estimators to reduce the possibility of falsely identifying features, which would deteriorate the classification performance.

In a first step with N different estimators, N metrical distances are calculated between two corresponding instances of the two different classes. In this exemplary embodiment, the estimators are T-Test, Wilcoxon Rank Sum Test, Entropy Test and a Kolmogorov Smirnov Test. In alternate embodiments, the presently disclosed concept allows the substitution or addition of alternate tests to the exemplary tests. Here:
(\vec{f}ⁱ_{A},\vec{f}ⁱ_{B}) |→distance, where (Equation 1)
\vec{f}ⁱ_{A} is the vector of feature i of the class A
\vec{f}ⁱ_{B} is the vector of feature i of the class B

In a second step, a corresponding p-value is calculated for each metric distance if it is possible analytically, such as, for instance, for the T-Test distance value and for the Wilcoxon-Test distance value:

$$p ( x , df ) = 1 - {I}_{z} ( \frac{df}{2} , \frac{1}{2} ) , where \qquad ( Equation 2 )$$

p: p-value
x: distance
df: degrees of freedom
I_{z}: incomplete Bessel Function

$$( z = \frac{ⅆ f}{ⅆ f + {x}^{2}} )$$

If it is not possible to calculate the p-value analytically, a different approach is followed by comparing the original distance with a large collection of randomly permuted vectors derived from the two original vectors. The p-value is then calculated as the fraction of random constellations, which generate a smaller distance than the original constellation:

$${p}_{i} = \frac{count ( {distance}_{i , perm} > {distance}_{i , obs} )}{count ( permutations )} , where \qquad ( Equation 3 )$$

p: p-value of feature i
distance_{j,perm} : distance of the two random vectors of feature i
distance_{j,obs} : distance of the two original vectors of feature i

In a third step, the different estimators are combined by choosing the highest measured p-value:
pᵣₑₛᵤₗₜ=Max(pᵢ) ∀iεN, where (Equation 4)
pᵣₑₛᵤₗₜ is the resulting p-value
Max(pᵢ) is the maximum of the p-values of all N tests performed

In a fourth step, the p-value is adjusted by a Bonferroni correction to limit the impact of large data sets:
pᵣₑₛᵤₗₜ =Min(1, NrObservation*pᵣₑₛᵤₗₜ), where (Equation 5)

“NrObservations” is the number of instances that are analyzed within the same test, for instance, in bioinformatics this could be the number of genes that are analyzed to identify marker genes in a micro array experiment.

In a fifth step, features that have a p-value higher than a certain threshold are rejected for further investigation, where the choice of the threshold depends on the specific application.

In alternate embodiments, variations of the method are possible. For example, if the user knows more about the type and distribution of the raw data, it is possible to apriori select the presumably best distance estimator. For instance, if the data are known to have large fluctuations, then the T-Test and the Wilcoxon-rank-sum test might be better choices than the entropy or Kolmogorov-Smirnov test. If the amount of data is extremely large and the computational time is a crucial issue, the analytical calculation of the p-value can be favored in contrast to the numerical approach.

In addition, the exemplary embodiment method allows for the incorporation of new and more specific distance estimators for the analysis of single features, and is extendable to analyze correlations between features to extract complex feature patterns.

In another exemplary embodiment, Bayesian networks and a Bayesian network learning based framework are provided, and a proteomic mass spectrum data set is used to illustrate in detail how an approach operates using the provided framework. Bayesian networks are powerful tools for knowledge representation and inference under conditions of uncertainty. A Bayesian network is a directed acyclic graph (DAG) <N,A> where each node n εN represents a domain variable, and each arc a εA between nodes represents a probabilistic dependency, quantified using a conditional probability distribution (CP table) θᵢεΘ for each node nᵢ. A BN can be used to compute the conditional probability of one node, given values assigned to the other nodes. Hence, a BN can be used as a classifier that gives the posterior probability distribution of the class node given the values of other attributes. A major advantage of BNs over many other types of predictive models, such as neural networks, is that the Bayesian network structure represents the inter-relationships between the dataset attributes. Human experts can easily understand the network structures, and if necessary, modify them to obtain better predictive models.

A Markov boundary of a node y in a BN will be introduced, where y's Markov boundary is a subset of nodes that “shields” y from being affected by any node outside the boundary. One of y's Markov boundaries is its Markov blanket, which is the union of y's parents, y's children, and the parents of y's children. When using a BN classifier on complete data, the Markov blanket of the classification node forms a natural feature subset, as all features outside the Markov blanket can be safely deleted from the BN.

Although the arrows in a Bayesian network are commonly explained as causal links, in classifier learning, the class attribute is normally placed at the root of the structure in order to reduce the total number of parameters in the CP tables. For convenience, one can imagine that the actual class of a sample ‘causes’ the values of other attributes.

The framework of the present disclosure is based on an efficient BN learning algorithm. It has three components including data pre-processing and feature filtering, BN classifier learning, and cross-validation based performance evaluation.

Data pre-processing is extremely domain specific. For example, in mass spectrum protein expression data, the pre-processing normally includes spectrum normalization, smoothing, peak identification, baseline subtraction and the like.

In machine learning datasets, there are often thousands of features and the majority of them have no correlation with the target variable at all. When the sample size is small, some irrelevant features may seem to be significant. The goal of feature filtering is to filter out as many irrelevant features as possible, without throwing away useful features. Researchers have applied various parametric and nonparametric statistics to rank the features and select the cutoff point. For example, several nonparametric methods have been studied.

For ease of explanation, exemplary embodiments of the present disclosure use a t-test or mutual information test as set forth in Equation 1 to measure the correlations between each feature and the target variable, and then remove the features that have little or no correlation with the target variable. However, other methods as known in the art may be applied as needed.

$$I ( A , B ) = {\sum }_{a , b} P ( a , b ) log \frac{P ( a , b )}{P ( a ) P ( b )} \qquad ( Equation 6 )$$

A unique BN learning algorithm is provided, based on three-phase dependency analysis, which is especially suitable for data mining in high dimensional data sets due to its efficiency. Here, the complexity is roughly O(N²) where N is the number of features. Following study of learning Bayesian networks as classifiers, the empirical results on a set of standard benchmark datasets show that Bayesian networks are excellent classifiers. In addition, Bayesian network learning system embodiments have been developed for general Bayesian network learning and for classifier learning.

The exemplary BN learning algorithm requires discrete (categorical) data. For numerical features, discretization is performed before model learning. The discretization procedure can be based on domain knowledge or some discretization algorithms. Entropy binning is one of such algorithms that minimize the information loss between the feature and the target variable.

Because the sample sizes of machine learning datasets are rarely large enough to set aside a portion of the samples as a test set, embodiments use a standard cross-validation procedure to evaluate model performances in most of the studies. In a k-fold cross-validation procedure, the dataset is partitioned into k disjoint subsets and cross validation is performed k times, each time using a different subset as the validation set and the rest of the k−1 subsets as the training set. The performances of k validation sets are then combined to get the final validation performance. 10 -fold cross-validation may normally be performed when the sample sizes are larger than one hundred, and leave one out cross-validation, where the number of folds is equal to the number of samples, may otherwise be performed.

When performing cross-validation, one needs to make sure that the validation set of each iteration is truly independent of the training set. That is, that there is no information leak between the training and validation sets. Information leak will occur when the feature filtering or data discretization is performed on the whole data set, rather than on the training set of each iteration of the cross validation.

An exemplary application in Proteomic Mass Spectrum Analysis is now presented. Proteomic mass spectrum data are acquired from body fluid samples using mass spectrometry techniques. Compared to gene expression analysis, proteomic pattern or protein expression analysis is a relatively new research field in machine learning. The idea behind such research is that the proteomic patterns of body fluids like blood serum can reflect the pathologic states of organs and tissues. Proteomic pattern analysis can either be applied directly as a new tool for cancer screening and diagnosis or be used to find the corresponding proteins and develop new assays for cancer diagnosis. Various public and nonpublic proteomic mass spectrum datasets have been analyzed using the exemplary method in several different cancer research projects, and produced encouraging results.

A public dataset for prostate cancer diagnosis is used to show the approach to such tasks. This dataset has been studied before, and contains 190 samples from patients with benign prostate conditions, 63 samples from health people, and 69 patients with prostate cancer. Because the goal of the study is to see whether proteomic patterns can be used as an auxiliary tool to accompany the standard prostate-specific antigen (PSA) test, we omit the 63 healthy samples with PSA<1 and only use the rest of the 259 samples that all have PSA >4.

The two mass spectra are in the mass range of 1900 to 16500 Da. The raw dataset contains one spectrum for each sample. There are 15154 data points in each mass spectrum with the mass range (m/z) from 0 to 20,000 Da. In this study, the range from 0 to 1,200 Da at the beginning of each spectrum was ignored because of the high noise level. This leaves 11441 data points for each spectrum.

The height of the same peak in a mass spectrum can vary in different runs using the same sample. To make the spectra comparable, normalization is usually performed. Common methods include the sum of intensity-based method and the standard normal variate correction method. Because the mass accuracy is normally 0.1% to 0.3%, there are often too many data points in the mass spectroscopy readout. Smoothing can be performed to lower the resolution and reduce noise. For this data set, the sum of intensity was used to normalize the spectra and the spectra were smoothed by averaging the neighboring 8 data points.

Peak identification is normally required because the peaks in mass spectra represent different peptides/proteins, which can be used as biomarkers for cancer diagnosis. The peaks may be discovered by a simple computer program or by visually examining the spectra, for example. A mass spectrum normally exhibits a base noise level, which varies across the m/z axis. Therefore, a certain kind of local correction is required to remove this base noise, such as a fixed window based method or a local linear regression based method. Here, a fixed window based tool is used to automatically discover peaks and do baseline correction, such as adjusting the peak height, at the same time.

After the preprocessing step, each spectrum contains 1431 data points or features. In each spectrum, if a data point is at the location of a peak, the value of the data point is the adjusted height of the peak. The data points have value zero if they are at the non-peak region. The exemplary embodiment method automatically detected about 9400 peaks in total, about 36.5 peaks per spectrum. Many of the features are in non-peak region across all the spectra. These features are discarded. The dataset, after preprocessing, has about 280 features.

Although a dataset with 280 features is already quite manageable, one may still want to filter out the irrelevant features for efficiency reasons. The entropy binning method may be used to discretize the data and calculate the mutual information, as in Equation 1, between each feature and the target variable. The result shows that only the top 70 features or peaks are correlated to the target variable. In order not to wrongly discard any useful features, 180 features were filtered out.

It shall be understood that the above procedure is used to give an approximation of how many features can be safely filtered out. Because different Bayesian network models are evaluated using cross-validation, the feature filtering and feature discretization need to be performed only on the training set during each iteration of cross validation to avoid information leak.

For BN classifier learning, a BN Power Predictor system is used. This system takes as input the training set with 100 features. The sample size of the training set is 90% of the total 259 cases in 10-fold cross-validation.

The system outputs a Bayesian network that has a structure that shows the dependencies between the target variable and the 100 features, and also shows the dependencies between the 100 features. The system uses the Markov blanket concept to automatically simplify the structure to keep only the features that are on the Markov blanket of the target variable. This feature selection is a natural by-product of the model learning and no wrapper approach is used to get the optimal feature subset. The number of features on the Markov blanket is related to the complexity of the BN model. A more complex BN model with many connections between the nodes or features will be likely to have more features on the Markov blanket. The complexity of the learned BN model is controlled by one parameter. The range of the appropriate parameters to use is normally known based on the sample size and the strength of the correlations between the features. A few parameters within the range are often used to find the best one.

A single run of the BN Power Predictor system takes about 30 seconds for such datasets with about 250 cases and 100 features, on an average PC. So the 10 fold cross-validation will take about 5 minutes. The running time is roughly linear to the number of samples and O(N²) to the number of features.

Based on the sample size, 10-fold cross-validation was used. After getting 10 pairs of training and validation sets, feature filtering (selecting top 100 features from 280 features) and feature discretization were performed on each of the training sets. This process takes about 1 minute.

Ten-fold cross-validation was performed 6 times, each time using a different threshold to control the model complexity. The different threshold settings are referred to as Threshold1 to Threshold6, with Threshold 1 being the smallest threshold. Using Threshold 1, the models in all 10 iterations of the cross validation have about 20 features, on average. The models of Threshold6 have about 10 features, on average. The results of 10 validation sets using each threshold setting are combined into one ROC curve. The areas under the ROC (AUROC) for Threshold1 to Threshold6 are 0.88, 0.88, 0.87, 0.87, 0.86, 0.84, which suggests that the models obtained using Threshold6 are probably too simple (i.e., under-fitting).

For sensitivity 0.90, the range of the specificities of the six settings is from 0.69 to 0.56 with mean 0.63. If the required sensitivity is 0.80, the range of the specificities of the six settings is between 0.70 and 0.81. Considering that the traditional prostate-specific antigen (PSA) method has a specificity around 0.25, this is already quite encouraging. Furthermore, the patients currently classified as having benign condition may develop prostate cancer later on, so the actual specificity can be higher.

The exemplary embodiment framework has also been successfully applied to gene expression and drug discovery datasets. The datasets are a well-known Leukemia gene expression dataset and the KDD Cup 2001 drug discovery dataset. The Leukemia gene expression dataset contains 72 samples of Leukemia patients belonging to two groups: acute myeloid leukemia (AML) and acute lymphoblastic leukemia (ALL). For each patient, gene expression data of about 7000 genes were generated. The dataset has already been preprocessed and absolute calls (to categorize the values into present, marginal or absent) were generated using a predetermined threshold.

By calculating the mutual information between each gene and the target variable, it was decided to keep 150 genes and filter out the rest. This procedure needs to be carried out during each iteration of the cross validation. Because of the small sample size, leave one out cross-validation was used. Leave one out cross-validation was run four times using four different thresholds. The BN models generated with the smallest threshold have 12 genes on average, while the models generated with the largest threshold have only 4 genes on average. The number of validation errors for the four thresholds (from small to large) are: 1, 0, 2, 2. The average misclassification rate of the four settings is only 1.7%. The total run time of this experiment is less than 2 hours on an average PC.

The Compound Screening for Drug Discovery dataset was provided for KDD Cup data mining competition. The goal was to predict whether a compound could actively bind to a target site on thrombin. The training set has 1909 compounds, in which only 42 are positive. Each compound is represented by 139,351 binary features. The test set contains 634 unlabelled compounds. After calculating the mutual information between each feature and the target variable, it was found to be safe to keep only the top 100 features. Because of the constraint of time and computing resources at that time, the cross-validation was skipped and several models were learned from the whole dataset using different thresholds, and training errors were produced in terms of AUROC rather than validation errors from cross-validation. The number of features on the Markov blanket of these models is from 2 to 12. To avoid over fitting the data, the simplest model having decent training error was picked, and it only contains four features. This model ranked the highest of over 120 solutions.

When learning predictive models from machine learning datasets, effective feature reduction and rigorous model validation are important. BN learning based frameworks of the present disclosure combine feature filtering and Markov blanket feature selection to discover the biomarkers, and apply cross-validation and AUROC to evaluate different models. Compared to the wrapper approach based biomarker discovery, such as used in the genetic algorithm, the presently disclosed BN Markov blanket based approach is much more efficient in that no search algorithm is needed to wrap around the core model learning algorithm.

In another exemplary embodiment method, a combination of feature selection and Bayesian networks is used for enhanced pattern recognition and classification. A detailed analysis of data for the purpose of pattern identification requires both a careful selection of reliable features as well as comprehensive and consistent model building. The exemplary combination embodiment presents a new method, which combines two novel techniques for both purposes.

In a first step, features are extracted. The exemplary method is intended for a two-class problem, where each class is represented by a set of instances, and each instance contains feature values in the form of a vector. The method analyzes whether two vectors for the same feature from two different classes are well separated. For that purpose the method combines four different tests, including a T-Test, a Wilcoxon Rank Sum Test, an Entropy Test, and a Kolmogorov Smirnov Test. Each test generates a certain distance derived from a metric defined by the test. This distance is then compared to an ensemble of distances, which is calculated from random feature vectors stemming from the original feature vectors.

The ratio of distances, which indicate the similarity between two random feature vectors compared to the original feature vectors and all ensemble distances, result in a p-value. The p-value is the statistical significance that the two feature vectors have different origins.

Depending on the requirements of the model-building algorithm, it is possible to combine the four different p-values into a single p-value for subsequent analysis. In case the number of instances is very large, the p-values may be adjusted by a Bonferroni correction to limit the probability of misidentifying features merely by chance.

In a second step, different Bayesian network classifiers are learned based on different feature filtering methods. Bayesian networks are powerful tools for data mining and data classification. When applied to bioinformatics problems such as gene and protein expression analysis, feature filtering may be applied first to remove the irrelevant features. This step usually reduces the number of features to several hundred. In practice, these features are also ranked from most important to least important using the p-value. When learning a Bayesian network, this ranking information is used in such a way that more important features have a better chance to be included in the final model. The final Bayesian network only contains a small subset of features. Therefore, it is possible that different rankings of the features will result in different Bayesian networks, even though the data set is essentially the same.

When applying different feature filtering methods, slightly different p-value rankings are normally obtained. The differences can sometimes be larger when the data are noisy or the sample size is small. Unfortunately, bioinformatics data sets often show these characteristics. This is why researchers developed different feature filtering techniques for bioinformatics data. Although it is possible to combine the different feature filtering techniques in the data pre-processing stage, the present embodiment combines the models learned using each feature filtering technique.

In a third step, different Bayesian networks are combined using model averaging. The exemplary embodiment method framework works as follows: Use each feature filtering method to pre-process the raw data and rank the importance of features using p-values; learn one Bayesian network using the feature ranking of each feature filtering method; calculate the posterior probability of each case in the data set using all Bayesian networks; and combine the results of different Bayesian networks by averaging the posterior probabilities.

In yet another exemplary method embodiment of the present disclosure, model stacking and averaging are improved by resealing classifier outputs. With reference to FIG. 6, model stacking is a technique for combining models and improving model performance, as it can reduce both bias and variance in model learning. The basic idea is to train different base classifiers from the training data, and then use the numerical outputs of the base classifiers, which comprise a score for each case, as inputs to train a higher-level classifier to classify data. Each base classifier and the higher-level classifier can be based on different formalisms. This model combination technique is independent of the choices of base classifiers. Model averaging and weighted model averaging can be considered as special cases of model stacking, where the higher-level classifier is a simple linear function. There are also voting based classifier combining methods. However, the final output for voting based classifier combining methods is just the binary decisions, which cannot be used to rank the instances and calculate the ROC curve.

For stacking and model averaging, one normally needs to standardize or rescale the output of each base classifier, as the output of different classifiers may have different range and characteristics. The goal of the rescaling is to bring the output to the same scale and make the distance between two new scores reflect the difference in the probability distribution to some degree.

It is preferable to standardize the outputs of classifiers to the posterior probability of the instances. Then one can combine the probabilities from different classifiers by averaging, weighted averaging or learning a new model. However, it is difficult to accurately map a classifier's numerical output to true probabilities. The commonly used method of mapping classifier's output to probabilities is to order the instances using the numerical output and draw a histogram. For example, one can calculate that top 10% of the instances based on the classifier's output have 0.98 probability of being class 1; and next 10% of instances have 0.75 probability of being class 1, etc. The problem with this method is that the histograms are not very smooth and accurate unless there are a large number of instances to support very fine binning. This decreases the ability of the higher-level classifier to discern instances that have small differences in the outputs of the base classifiers.

By studying the histograms of some base classifiers, it is noticed that the probabilities normally increase or decrease monotonically with the classifier's original scores when the classifiers are not too weak. As long as the difference between the re-scaled outputs can reflect the difference of the probability of the two instances being class 1, one does not really need the re-scaled outputs to be probabilities.

Based on the assumption that the original outputs are semi-monotonic to the true probability, a novel method is developed to scale the outputs. The basic idea is to count the accumulated probabilities after sorting the instances rather than estimate the probabilities using histogram. In this way, the estimation can be smooth and accurate so that the higher-level model can still have the abilities to rank similar instances correctly.

The exemplary embodiment algorithm focuses on two-class problems. Multi-class problems can be converted into several two-class problems. In operation, the original scores of all training cases are sorted from large to small for each base classifier. Here, it is assumed that a high score means that the cases are more likely to be class 1. Then, for each distinct score in the ordering, the new score is calculated as the accumulated probability of being class 1.

From the above measurement, it can be seen that the difference between any two new scores reflects the number of class 1 cases in between the two cases in the original score ranking. That is, it shows the difference of the capability of the two scores to catch class 1 cases.

In an exemplary application, a data set with about 146K instances is used to test the algorithm. 21 features are selected to simulate the output of 21 base models. The Area under ROC performance of a single feature is in the range from 0.799 to 0.94.

For comparison, the commonly used histogram approach is first used to estimate the probabilities of each score, and then averaging the probabilities. The combined model has area under ROC curve of 0.96. It is attempted to smooth the estimated probabilities. This gives a slightly better performance AUROC=0.963.

The next method tried was averaging the ranks of each instance given by the 21 original scores. Surprisingly, the performance is AUROC=0.975.

Finally, the exemplary embodiment algorithm is used to rescale the scores and combine the model by averaging. The performance obtained is AUROC=0.985. In alternate embodiments, it is planed to use a more sophisticated higher-level model to combine the base classifiers rather than the simple averaging used above. This algorithm outperforms the probability histogram and the simple ranking using higher-level model, such as SVM or logistic regression.

It is to be understood that the teachings of the present disclosure may be implemented in various forms of hardware, software, firmware, special purpose processors, or combinations thereof. Most preferably, the teachings of the present disclosure are implemented as a combination of hardware and software.

Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (CPU), a random access memory (RAM), and input/output (I/O) interfaces.

The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. For example, the exemplary method for determining how many features should be filtered out may be augmented or replaced with more sophisticated feature filtering techniques. For another example, the algorithm frameworks for machine learning may be incorporated into advanced medical decision support systems that are based on multi-modal data, such as clinical data, genetic data, proteomic data and imaging data. All such changes and modifications are intended to be included within the scope of the present disclosure as set forth in the appended claims.

What is claimed is:

1. A method of machine learning comprising:
receiving instances for two different classes, each instance having a vector of feature values;
estimating distances between two corresponding instances of the two different classes for each of a plurality of estimators;
calculating a corresponding p-value for each distance, where the p-value is the statistical significance that the two feature vectors of the corresponding instances have different origins; and
combining the different estimators by choosing the highest calculated p-value.

2. A method as defined in claim 1, further comprising adjusting the p-values by a Bonferroni correction to limit the impact of large data sets.

3. A method as defined in claim 1, further comprising rejecting features that have a p-value higher than a threshold.

4. A method as defined in claim 1 wherein the plurality of estimators includes at least one of T-Test, Wilcoxon Rank Sum Test, Entropy Test and Kolmogorov Smirnov Test.

5. A method as defined in claim 1 wherein a corresponding p-value is calculated analytically for a distance.

6. A method as defined in claim 5 wherein the amount of data is large and the computational time is an issue.

7. A method as defined in claim 1 wherein a corresponding p-value is calculated numerically for a distance by comparing the original distance with a large collection of randomly permuted vectors derived from the two original vectors, and calculating the p-value as the fraction of random constellations that generate a smaller distance than an original constellation.

8. A method as defined in claim 1, further comprising selecting the presumable best distance estimator apriori if the type and distribution of the raw data is known.

9. A method as defined in claim 1 wherein specific distance estimators are applied for the analysis of single features.

10. A method as defined in claim 1, further comprising analyzing correlations between features to extract complex feature patterns.

11. A machine learning system comprising:
a processor;
an adapter in signal communication with the processor for receiving instances for two different classes, each instance having a vector of feature values;
a filtering unit in signal communication with the processor for estimating distances between two corresponding instances of the two different classes for each of a plurality of estimators;
a selection unit in signal communication with the processor for calculating a corresponding p-value for each distance, where the p-value is the statistical significance that the two feature vectors of the corresponding instances have different origins; and
an evaluation unit in signal communication with the processor for combining the different estimators by choosing the highest calculated p-value.

12. A system as defined in claim 11, further comprising correction means in signal communication with the processor for adjusting the p-values by a Bonferroni correction to limit the impact of large data sets.

13. A system as defined in claim 11, further comprising thresholding means in signal communication with the processor for rejecting features that have a p-value higher than a threshold.

14. A system as defined in claim 11 wherein the filtering unit for estimating includes means in signal communication with the processor for at least one of T-Test, Wilcoxon Rank Sum Test, Entropy Test and Kolmogorov Smirnov Test.

15. A system as defined in claim 11, further comprising analytical calculation means in signal communication with the processor for calculating a corresponding p-value for a distance.

16. A system as defined in claim 11, further comprising numerical calculation means in signal communication with the processor for calculating a corresponding p-value for a distance by comparing the original distance with a large collection of randomly permuted vectors derived from the two original vectors, and calculating the p-value as the fraction of random constellations that generate a smaller distance than an original constellation.

17. A system as defined in claim 11, further comprising selection means in signal communication with the processor for selecting the presumable best distance estimator apriori if the type and distribution of the raw data is known.

18. A system as defined in claim 11, further comprising single feature analysis means in signal communication with the processor for applying specific distance estimators for the analysis of single features.

19. A system as defined in claim 11, further comprising feature pattern means in signal communication with the processor for analyzing correlations between features to extract complex feature patterns.

20. A program storage device responsive to the method of claim 1, where the device is readable by machine and tangibly embodies a program of instructions executable by the machine to perform program steps for machine learning, the program steps comprising:
receiving instances for two different classes, each instance having a vector of feature values;
estimating distances between two corresponding instances of the two different classes for each of a plurality of estimators;
calculating a corresponding p-value for each distance, where the p-value is the statistical significance that the two feature vectors of the corresponding instances have different origins; and
combining the different estimators by choosing the highest calculated p-value.

21. A method of machine learning comprising:
receiving instances for two different classes, each instance having a vector of feature values;
extracting features to analyze whether two vectors for the same feature from two different classes are well separated;
combining a plurality of tests, each of which generates a distance derived from a metric defined by the test;
comparing each distance to an ensemble of distances that is calculated from random feature vectors stemming from the original feature vectors;
computing a ratio of distances indicative of the similarity between two random feature vectors compared to the original feature vectors and the ensemble of distances;
providing a p-value responsive to the ratio, where the p-value is the statistical significance that the two feature vectors have different origins; and
learning a plurality of different Bayesian network classifiers in response to a plurality of different feature filtering tests, respectively.

22. A method as defined in claim 21, the plurality of tests comprising at least one of a T-Test, a Wilcoxon Rank Sum Test, an Entropy Test, and a Kolmogorov Smirnov Test.

23. A method as defined in claim 21, further comprising combining different p-values corresponding to the plurality of tests into a single p-value for subsequent analysis.

24. A method as defined in claim 21, further comprising adjusting the p-values by a Bonferroni correction to enhance the probability of correctly identifying features where the number of instances is large.

25. A method as defined in claim 21, further comprising ranking the features from most important to least important in accordance with the p-value such that more important features have a better chance to be included in the final model.

26. A method as defined in claim 25 wherein different rankings of the features result in different Bayesian networks, even though the data set is essentially the same, where the final Bayesian network only contains a small subset of the features, and each Bayesian network is obtained by:
receiving data;
pre-processing the data;
filtering features of the data;
learning a Bayesian network (BN) classifier;
selecting features responsive to the BN classifier; and
evaluating a model responsive to the BN classifier.

27. A method as defined in claim 21, further comprising combining the different feature filtering tests in a data pre-processing stage.

28. A method as defined in claim 21, further comprising combining the models learned using each feature-filtering test.

29. A method as defined in claim 21, further comprising combining different Bayesian networks using model averaging.

30. A method as defined in claim 21, further comprising:
pre-processing raw data using each feature filtering test;
ranking the importance of features using p-values;
learning one Bayesian network using the feature ranking of each feature filtering method;
calculating the posterior probability of each case in the data set using all Bayesian networks; and
combining the results of different Bayesian networks by averaging the posterior probabilities.

31. A machine learning system comprising:
a processor;
an adapter in signal communication with the processor for receiving instances for two different classes, each instance having a vector of feature values;
a filtering unit in signal communication with the processor for extracting features to analyze whether two vectors for the same feature from two different classes are well separated, and for combining a plurality of tests, each of which generates a distance derived from a metric defined by the test;
a selection unit in signal communication with the processor for comparing each distance to an ensemble of distances that is calculated from random feature vectors stemming from the original feature vectors, and for computing a ratio of distances indicative of the similarity between two random feature vectors compared to the original feature vectors and the ensemble of distances; and
an evaluation unit in signal communication with the processor for providing a p-value responsive to the ratio, where the p-value is the statistical significance that the two feature vectors have different origins, and for learning a plurality of different Bayesian network classifiers in response to a plurality of different feature filtering tests, respectively.

32. A system as defined in claim 31, further comprising test means in signal communication with the processor including at least one of a T-Test, a Wilcoxon Rank Sum Test, an Entropy Test, and a Kolmogorov Smirnov Test.

33. A system as defined in claim 31, further comprising p-value combination means in signal communication with the processor for combining different p-values corresponding to the plurality of tests into a single p-value for subsequent analysis.

34. A system as defined in claim 31, further comprising correction means in signal communication with the processor for adjusting the p-values by a Bonferroni correction to enhance the probability of correctly identifying features where the number of instances is large.

35. A system as defined in claim 31, further comprising ranking means in signal communication with the processor for ranking the features from most important to least important in accordance with the p-value such that more important features have a better chance to be included in the final model.

36. A system as defined in claim 31, further comprising pre-processing means in signal communication with the processor for combining the different feature filtering tests in a data pre-processing stage.

37. A system as defined in claim 31, further comprising model combination means in signal communication with the processor for combining the models learned using each feature-filtering test.

38. A system as defined in claim 31, further comprising network combination means in signal communication with the processor for combining different Bayesian networks using model averaging.

39. A system as defined in claim 31, further comprising:
data pre-processing means in signal communication with the processor for pre-processing raw data using each feature-filtering test;
p-value ranking means in signal communication with the processor for ranking the importance of features using p-values;
Network-learning means in signal communication with the processor for learning one Bayesian network using the feature ranking of each feature filtering method;
posterior probability means in signal communication with the processor for calculating the posterior probability of each case in the data set using all Bayesian networks; and
network combination means in signal communication with the processor for combining the results of different Bayesian networks by averaging the posterior probabilities.

40. A program storage device responsive to the method of claim 21, where the device is readable by machine and tangibly embodies a program of instructions executable by the machine to perform program steps for machine learning, the program steps comprising:
receiving instances for two different classes, each instance having a vector of feature values;
extracting features to analyze whether two vectors for the same feature from two different classes are well separated;
combining a plurality of tests, each of which generates a distance derived from a metric defined by the test;
comparing each distance to an ensemble of distances that is calculated from random feature vectors stemming from the original feature vectors;
computing a ratio of distances indicative of the similarity between two random feature vectors compared to the original feature vectors and the ensemble of distances;
providing a p-value responsive to the ratio, where the p-value is the statistical significance that the two feature vectors have different origins; and
learning a plurality of different Bayesian network classifiers in response to a plurality of different feature filtering tests, respectively.

41. A method of machine learning comprising:
receiving instances for two different classes, each instance having a vector of feature values;
providing a plurality of models responsive to the classes, each model having at least one base estimator or classifier; and
using numerical outputs from the plurality of models as inputs to train a higher-level classifier for model stacking, where each base classifier and the higher-level classifier may be based on a different formalism.

42. A method as defined in claim 41 wherein the model stacking comprises model averaging and the higher-level classifier is a linear function.

43. A method as defined in claim 42 wherein the model averaging comprises weighted model averaging.

44. A method as defined in claim 41, further comprising rescaling the outputs of the base classifiers to the posterior probabilities of the instances.

45. A method as defined in claim 44, further comprising combining the probabilities from different classifiers by averaging, weighted averaging, or learning a new model.

46. A method as defined in claim 41, further comprising resealing the outputs of the base classifiers to the order of the instances using the numerical outputs.

47. A method as defined in claim 41, further comprising resealing the outputs of the base classifiers to increase or decrease monotonically with the original scores of the classifiers.

48. A method as defined in claim 47 wherein the difference between the rescaled outputs reflects the difference of the probability of the two instances being of the same class, and the resealed outputs need not be probabilities.

49. A method as defined in claim 41, further comprising counting the accumulated probabilities after sorting the instances rather than estimating the probabilities using a histogram such that the estimation is smooth and accurate and the higher-level model maintains the ability to rank similar instances correctly.

50. A method as defined in claim 49 wherein the application is a multi-class problem, the method further comprising converting the multi-class problem into a plurality of two-class problems.

51. A machine learning system comprising:
a processor;
an adapter in signal communication with the processor for receiving instances for two different classes, each instance having a vector of feature values;
a filtering unit in signal communication with the processor for pre-processing the instances and filtering features of the instances;
a selection unit in signal communication with the processor for providing a plurality of models responsive to the classes, each model having at least one base estimator or classifier; and
an evaluation unit in signal communication with the processor for using numerical outputs from the plurality of models as inputs to train a higher level classifier for model stacking, where each base classifier and the higher level classifier may be based on a different formalism.

52. A system as defined in claim 51, further comprising averaging means in signal communication with the processor for averaging and the higher-level classifier is a linear function.

53. A system as defined in claim 51, further comprising resealing means in signal communication with the processor for rescaling the outputs of the base classifiers to the posterior probabilities of the instances.

54. A system as defined in claim 53, further comprising probability combination means in signal communication with the processor for combining the probabilities from different classifiers by averaging, weighted averaging, or learning a new model.

55. A system as defined in claim 51, further comprising resealing means in signal communication with the processor for resealing the outputs of the base classifiers to the order of the instances using the numerical outputs.

56. A system as defined in claim 51, further comprising resealing means in signal communication with the processor for resealing the outputs of the base classifiers to increase or decrease monotonically with the original scores of the classifiers.

57. A system as defined in claim 56, further comprising difference means in signal communication with the processor for providing a difference between the rescaled outputs that reflects the difference of the probability of the two instances being of the same class, where the rescaled outputs need not be probabilities.

58. A system as defined in claim 51, further comprising counting means in signal communication with the processor for counting the accumulated probabilities after sorting the instances rather than estimating the probabilities using a histogram such that the estimation is smooth and accurate and the higher-level model maintains the ability to rank similar instances correctly.

59. A system as defined in claim 58, further comprising multi-class means in signal communication with the processor for converting the multi-class problem into a plurality of two-class problems.

60. A program storage device responsive to the method of claim 41, where the device is readable by machine and tangibly embodies a program of instructions executable by the machine to perform program steps for machine learning, the program steps comprising:
receiving instances for two different classes, each instance having a vector of feature values;
providing a plurality of models responsive to the classes, each model having at least one base estimator or classifier; and
using numerical outputs from the plurality of models as inputs to train a higher-level classifier for model stacking, where each base classifier and the higher-level classifier may be based on a different formalism.
